(19) United States
(12) Patent Application Publication
(10) Pub. No.: US 2020/0340549 A1
(43) Pub. Date: Oct. 29, 2020

(54) RIGID CHAIN LINK AND RIGID CHAIN EQUIPPED WITH SUCH LINKS

(71) Applicant: LIFT 'O, Entraigues Sur La Sorgue (FR)

(72) Inventor: Antoine Bodechon, Entraigues Sur La Sorgue (FR)

(73) Assignee: LIFT 'O, Entraigues Sur La Sorgue (FR)

(21) Appl. No.: 16/434,864

(22) Filed: Jun. 7, 2019

(30) Foreign Application Priority Data
Apr. 24, 2019 (FR) 19 04330

(51) Int. Cl. F16G 13/20; F16G 13/07; F16G 15/12

(52) U.S. Cl. CPC F16G 13/20; F16G 15/12; F16G 13/07

(57) ABSTRACT

The subject of the invention is a link for a rigid chain, and a rigid chain obtained by assembly of identical links. Each link has a body that is approximately in the shape of a fork and is provided with a heel connected by a base to two parallel flanges separated by a space intended to receive the heel of an adjacent link, the heel and each flange having an orifice configured to receive a joint rotary pin for articulating a link with respect to an adjacent link.

The invention relates to a rigid chain link and to a rigid chain that is formed of such links and is capable of working rigidly in compression.

### PRIOR ART

The majority of known chains are designed with a free shape so as to work in traction between two coupling points. They are made up of links, typically made of steel, that are each interlinked with two adjacent links that are closed on themselves. Traction exerted on end links tensions the chain and allows it to be used in traction. In the traction position, the different links are aligned and form approximately a straight line. When the traction is released, the chain deforms under the effect of gravity and can then be stowed in a roll or as a stack of any shape.

A known chain variant is the articulated chain of the bicycle chain type. It differs from the chain of free shape in that the links have a particular shape formed by two pins connected by two lateral plates. This allows the chain to deform approximately in a plane, namely the plane of the crankset, but to resist deformation in a direction out of the plane of the crankset.

The two abovementioned types of chain can only work in traction and are not designed to exert thrust on an object, for example in order to raise or move a load.

For this purpose, chains known as rigid chains have been provided, which are provided with links that are articulated with respect to one another but are configured to be able to absorb a compression force without deforming.

The document EP 1006074 B1 (Serapid) describes such a rigid chain. It is made up of a set of links connected together. Each link has metal lateral plates having two orifices situated on one side of the plates, and a third orifice situated on the opposite side. The three orifices in each link form an isosceles triangle. The two orifices of the first side receive articulation pins that allow the articulation of the links with respect to one another. The third orifice receives a drive pin provided with a drive roller that cooperates with the teeth of a drive gear mechanism. In the straight position of the chain, two adjacent links are locked with respect to one another with the aid of notches that are formed in the plates and are positioned on the drive pins.

It has been found that this structure is relatively complex and requires the manufacture and assembly of a large number of different parts. Moreover, given that the parts are mainly metallic, this chain has a high weight. Moreover, it is not suitable for use in corrosive environments because the metal parts would degrade, threatening the stability of the chain.

### Aim of the Invention

The general aim of the invention is to provide a chain link for a rigid chain that is particularly simple and makes it possible to obtain a rigid chain that is inexpensive to manufacture and assemble, while being suitable for raising or moving heavy loads over a long distance.

The specific aim of the invention is to provide a chain link and a rigid chain that can be used in a wide variety of environments, including corrosive environments such as chlorinated water or salt water, for example in a swimming pool environment.

### Principle of the Invention

In principle, the invention provides a link and a series of links that are juxtaposed to form a chain, each link, apart from the end links, being connected to two adjacent links and being articulated with respect to the latter by a rotary pin.

The links are designed such that the rotation of one link with respect to its neighbor(s) is guided between end positions, and in one of these end positions, corresponding to the working position of the chain, the adjacent links are aligned in a straight line, whereas in the other positions, the assembled links form a curved line. In the working position, when the links are aligned, two adjacent links have contacting faces designed to be able to absorb a compression force, such that the chain as a whole can behave like a beam absorbing a compression force parallel to the direction of alignment of the links. Moreover, the links are designed in a rot-proof and corrosion-resistant material so as to be able to be used in a variety of environments, including corrosive liquids.

### Subject of the Invention

Therefore, a first subject of the invention is a link for a rigid chain, said link having a body that is approximately in the shape of a fork and is provided with a heel connected by a base to two parallel flanges separated by a space intended to receive the heel of an adjacent link, the heel and each flange having an orifice configured to receive a joint rotary pin for articulating a link with respect to an adjacent link.

According to the invention, the base has, on either side of the heel, two parallel shoulders configured to form a stop with respect to the ends of the flanges of an adjacent link. Preferably, the amplitude of articulation of two adjacent links is possible in an angular range limited to 90°, the angle of 0° corresponding to the alignment of the adjacent links along a straight line.

The end faces of the flanges are parallel to the faces of the shoulders and perpendicular to the compression force that is exerted on the links in the working position. In this way, when the adjacent links are aligned in a straight line, the shoulders of one link bear against the end faces of the flanges of an adjacent link, thereby making it possible to absorb a large compression force.

According to an advantageous embodiment, each flange and the heel of a link have an approximately rectangular shape with a rounded corner situated in the vicinity of the rotary pin.

Preferably, the distances between the rotary pin and the two perpendicular sides of the flanges and the two perpendicular sides of the heel that are adjacent to the rotary pin are the same, thereby allowing a maximum angular travel of 90° between two adjacent links.

Advantageously, the rotary pin is perpendicular to the main plane of symmetry of the link and offset toward the rear side of the link that is provided with the rounded portions.

Preferably, the radius of curvature of the rounded corners of the flanges and of the heel is greater than the distance between the rotary pin and the two perpendicular sides of the flanges and the two perpendicular sides of the heel that are adjacent to the rotary pin.

According to an advantageous embodiment, the heel has an orifice that receives a threaded fastening screw, the end of which is fitted into a tapped orifice in the rotary pin so as to secure the body of the link and the rotary pin thereof in terms of rotation. The rotary pin and the fastening screw thereof are made for example of stainless steel.

According to an advantageous embodiment, the body of the link is made of plastics material mixed with reinforcing fibers, notably glass fibers.

The body of the link is obtained by molding/injection molding or by rotational molding, or by 3D printing.

Alternatively, it could be obtained by assembly of a heel, a base and added flanges, but this embodiment would undoubtedly be more expensive.

A further subject of the invention is a rigid chain, which has a linear assembly of links according to the invention, such that the heel of one link is fitted into the space situated between the flanges of an adjacent link, a joint rotary pin being inserted into the orifices in the flanges of a link and the orifice in the heel of an adjacent link.

According to a particularly stable embodiment, the rigid chain has a linear assembly of chain elements, each chain element being made up of several unitary links as described above that are connected by a single rotary pin, a part of the rotary pin remaining free in order to allow engagement with a sprocket for driving the chain.

The invention will be understood better with the aid of the detailed description and the drawings, in which:

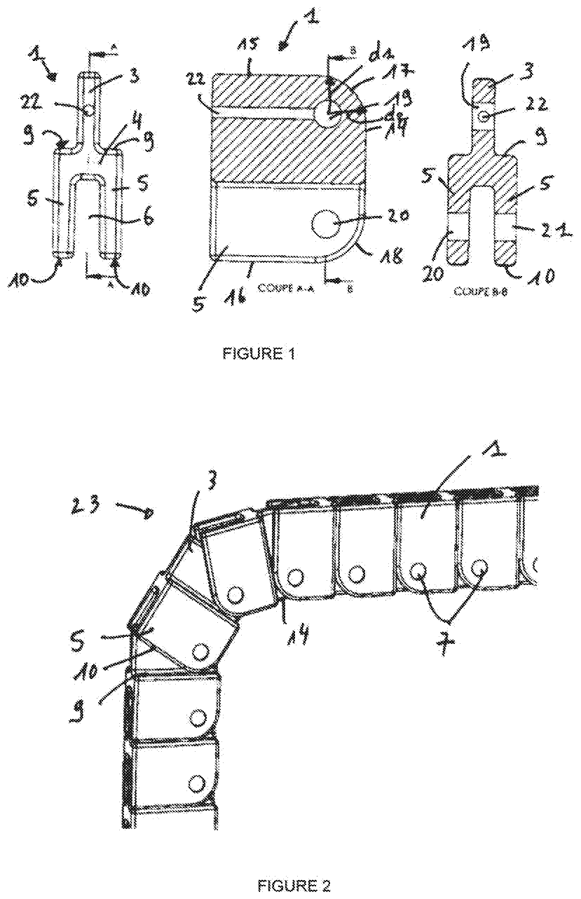

FIG. 1 shows elevation and sectional views of a unitary chain link according to the invention;

FIG. 2 shows a perspective view of a rigid chain formed by unitary links according to FIG. 1;

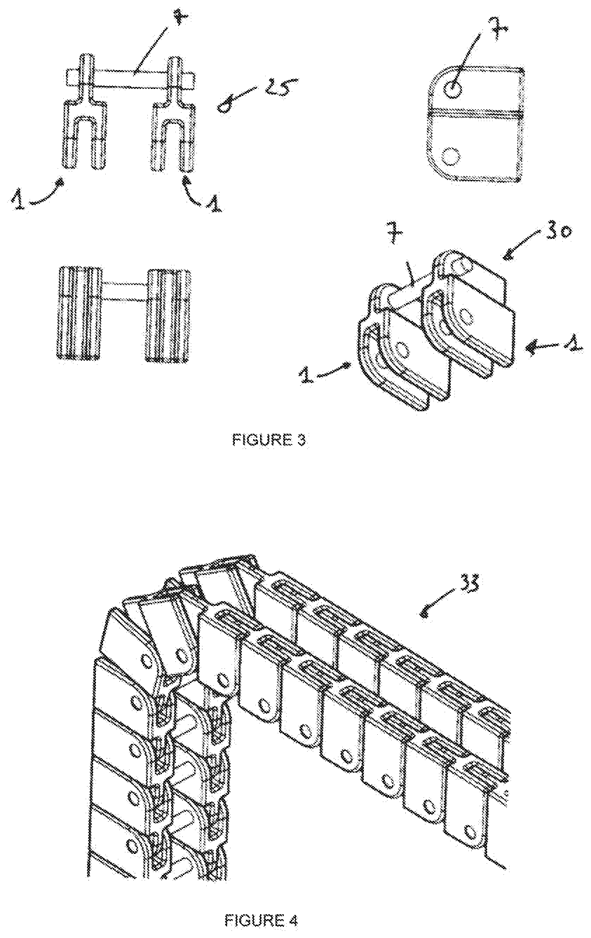

FIG. 3 shows elevation and perspective views of a chain element formed by two unitary links according to FIG. 1;

FIG. 4 is a perspective view of a rigid chain formed by chain elements according to FIG. 3;

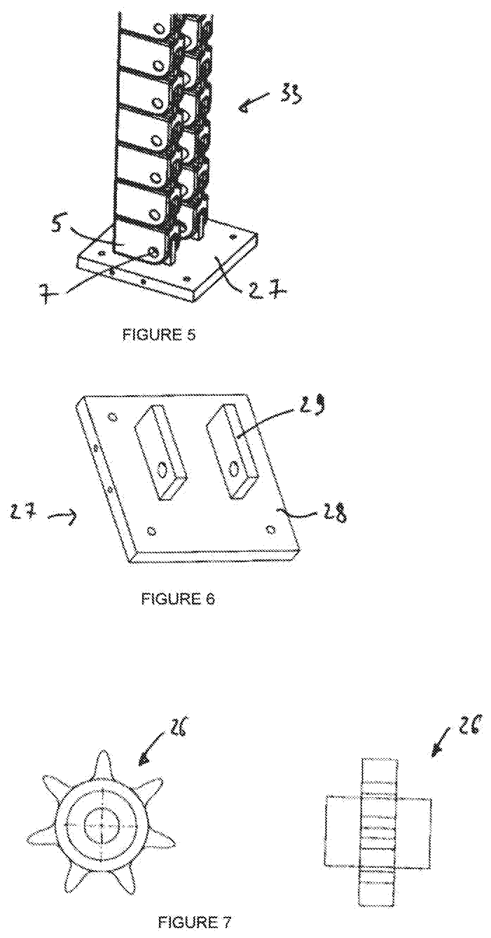

FIG. 5 shows a perspective view of one end of a rigid chain according to FIG. 4, provided with a foot;

FIG. 6 shows a perspective detail view of the foot of the chain according to FIG. 5;

FIG. 7 shows side and front views of a gearwheel that is usable to drive the rigid chains according to FIGS. 4 and 6.

### DETAILED DESCRIPTION

Reference is made to FIG. 1. The left-hand part of FIG. 1 shows a front elevation view of a unitary link 1 according to the invention. It has an approximately fork-shaped body 2. It is provided with a heel 3 connected by a base 4, perpendicular to the heel, to two parallel flanges 5 separated by a space 6 intended to receive the heel 3 of an adjacent link 1.

The heel 3 and each flange 5 have an orifice configured to receive a joint rotary pin 7 (not shown in this figure) for articulating a link with respect to an adjacent link.

The heel 3 and the flanges 5 have a generally parallelepipedal shape. The link 1 is symmetric with respect to a main plane of symmetry 8 passing through the median plane of the heel 3 and to the middle between the two flanges 5.

The base 4 has, on either side of the heel 3, two parallel shoulders 9 that are configured to form a stop with respect to the end faces 10 of the flanges of an adjacent link, when these two links are aligned. It is this stop that makes it possible to lock the links together and to absorb the compression forces to which they will be subjected.

To this end, the end faces 10 of the forks are parallel to the faces of the shoulders 9 and perpendicular to the compression force that is exerted on the links in the working position, in a direction parallel to the main plane of symmetry 8.

As can be seen in the central part of FIG. 1, which corresponds to a sectional view A-A of the link, the link 1 has, in this direction, an approximately rectangular shape that is delimited by sides 13, 14, 15, 16 but has two rounded corners 17, 18. The body 2 thus has a front side 13 and a rear side 14, an upper side 15 and a lower side 16, in the orientation shown. Orifices 19, 20, 21 that have the same diameter and are aligned in a line parallel to the rear side 14 and adjacent thereto are formed in the body 2 and intended to receive a rotary pin 7. The axis of the various orifices 19, 20, 21 is perpendicular to the main plane of symmetry 8 of the link and offset toward the rear side 14 of the link.

The orifice 19 is formed in the heel 3 of the link, and the orifices 20, 21 are formed in the flanges 5, as can be seen in the right-hand part of FIG. 1, which corresponds to a sectional view of the link on the section plane denoted B-B passing through the center of the orifices 19, 20, 21.

Preferably, the distances d1, d2 between the center of the orifices 19, 20 and the sides 14, 15, 16 of the flanges which are next to said orifices are all the same. Moreover, the centers of the rounded portions 17, 18 correspond respectively to the centers of the orifices 19, and (20, 21). Furthermore, the radii of curvature of the rounded portions 17, 18 are greater than the radius of the various orifices 19, 20, 21. This ensures that the rotation of two adjacent links is limited to an angular range of between 0° and 90°, the angle of 0° corresponding to the aligned position of the links, and thus to the stable working position of the chain.

According to a preferred embodiment of the link 1, the heel 3 also has a tapped orifice 22 that receives a threaded fastening screw (not shown), the end of which is fitted into a tapped orifice (not shown) formed in the rotary pin 7 so as to secure the body 2 and the rotary pin 7 thereof in terms of rotation.

According to an advantageous embodiment, the body 2 of the link 1 is made of plastics material mixed with reinforcing fibers, notably glass fibers, in a quantity to be determined depending on the desired mechanical strength.

In order for the link 1 to be able to be used without being damaged in a corrosive environment, it is useful for the rotary pin 7 and the fastening screw fitted therein to be made of stainless steel or some other corrosion-resistant material.

Several manufacturing methods are conceivable for manufacturing the body 2 of the link according to the invention. For economic, high-volume production, a method of injecting the plastics material charged with fibers into a mold and then demolding the parts after curing could be used. Alternatively, it may be possible to use techniques, known per se, of rotational molding, 3D printing, machining, or assembly of a heel 3, a base 4 and added flanges 5.

As shown in FIG. 2, in order to obtain a rigid chain 23 with links 1, it will be sufficient to produce a linear assembly of links 1 as described above, ensuring that the heel 3 of a given link is fitted into the space 6 between the flanges 5 of an adjacent link, and then to position and secure a rotary pin 7 in the orifices 20, 21 of one link and the orifice 19 of an adjacent link. The rotary pins 7 could protrude beyond at least one side of the links, so as to allow engagement with a gearwheel for driving the chain 23 thus formed, for example in a vertical movement for lifting a load.

In operation in a working position, the faces 10 of the flanges of a given link butt against the shoulders 9 of an adjacent link, thereby ensuring a sufficient contact area for absorbing the compression force.

The fact that the rotary pins 7 are offset toward the rear side 14 of the chain, toward which the chain can be curved, ensures stable locking of the chain when it is in a straight position.

FIGS. 3 and 4 show an embodiment variant which uses chain elements 25 that are each made up of two unitary links 1, as described above, mounted on a single rotary pin 7. The part of the pin 7 situated between the two links 1 remains free so as to allow driving by the sprocket 26 of a gear mechanism, as shown in FIG. 7. The drive of the sprocket is not shown.

In order to form a chain 33 as shown in FIG. 6, all that is necessary is to assemble the chain elements 25 in a linear manner.

This provision makes it possible to reinforce and stabilize the chain thus formed even further, but without changing the configuration of each unitary link 1.

Of course, if necessary, it is possible to mount more than two links 1 on one and the same pin 7, thereby further increasing the stability of the chain 33 with respect to any lateral forces.

In order to increase the stability of the chain 23, 33 in the working position, it may be useful to provide one or both of its ends with a foot 27. In the example shown in FIG. 5, which corresponds to a chain 33 used to lift a load (not shown), this foot 27 is applied to the ground, thereby increasing the coefficient of friction between the end of the chain 33 and the ground.

As shown in FIG. 6, the foot 27 will usefully have a base 28 with an area greater than the section of the chain 23, 33. This base 28 is secured to heels 29 which are fitted between the flanges 5 of the last link(s) 1 of the chain, to which they are fastened by a pin 7 identical to the other pins 7 of the chain.

### Advantages of the Invention

The invention meets the aims set. The unitary chain link 1 has a particularly simple design allowing very economical mass production, in particular by injecting a plastics material reinforced with fibers into a mold. The materials used can be chosen easily to optimize the resistance of the links depending on the use environment.

Each unitary link 1 comprises only three parts, namely a body 2, a rotary pin 7, and a screw for fastening the rotary pin with respect to the body.

If necessary, and depending on the intended stability and compression forces, the chain formed by a linear assembly of links 1 can be doubled by using several, for example two, bodies 2 mounted in parallel on one and the same rotary pin 7.

With such a design, the rigid chain 23, 33 according to the invention is suitable for raising or moving heavy loads over a long distance. The actuating distance is limited only by the length of the chain.

1. A link for a rigid chain, said link having a body that is approximately in the shape of a fork and is provided with a heel connected by a base to two parallel flanges separated by a space intended to receive the heel of an adjacent link, the heel and each flange having an orifice configured to receive a joint rotary pin for articulating a link with respect to an adjacent link.

2. The link as claimed in claim 1, wherein the base has, on either side of the heel, two parallel shoulders configured to form a stop with respect to the ends of the flanges of an adjacent link.

3. The link as claimed in claim 1, wherein the articulation of two adjacent links is possible in an angular range limited to 90°.

4. The link as claimed in claim 1, wherein the end faces of the flanges are parallel to the faces of the shoulders and perpendicular to the compression force that is exerted on the links in the working position.

5. The link as claimed in claim 1, wherein each flange and the heel have an approximately rectangular shape with a rounded corner situated in the vicinity of the rotary pin.

6. The link as claimed in claim 1, wherein the distances between the rotary pin and the two perpendicular sides of the flanges and the two perpendicular sides of the heel that are adjacent to the rotary pin are the same.

7. The link as claimed in claim 1, wherein the rotary pin is perpendicular to the main plane of symmetry of the link and offset toward the rear side of the link.

8. The link as claimed in claim 5, wherein the radius of curvature of the rounded corners of the flanges and of the heel is greater than the distance between the rotary pin and the two perpendicular sides of the flanges and the two sides of the heel that are adjacent to the rotary pin.

9. The link as claimed in claim 1, wherein the heel has an orifice that receives a threaded fastening screw, the end of which is fitted into a tapped orifice in the rotary pin so as to secure the body of the link and the rotary pin thereof in terms of rotation.

10. The link as claimed in claim 1, wherein the body of the link is made of plastics material mixed with reinforcing fibers, notably glass fibers.

11. The link as claimed in claim 1, wherein the rotary pin and the fastening screw thereof are made of stainless steel.

12. The link as claimed in claim 1, wherein the body of the link is obtained by molding/injection molding or by rotational molding.

13. The link as claimed in claim 1, wherein the body of the link is obtained by 3D printing.

14. The link as claimed in claim 1, wherein the body of the link is obtained by assembly of a heel, a base and added flanges.

15. A rigid chain, which has a linear assembly of links as claimed in claim 1, such that the heel of one link is fitted into the space situated between the flanges of an adjacent link, the rotary pin being inserted into the orifices in the flanges of a link and the orifice in the heel of the adjacent link.

16. A rigid chain, which has a linear assembly of chain elements, each chain element being made up of several links as claimed in claim 1 connected by a single rotary pin, a part of the rotary pin remaining free in order to allow engagement with a sprocket for driving the chain.
